(19) United States
(12) Patent Application Publication
(10) Pub. No.: US 2012/0226637 A1
(43) Pub. Date: Sep. 6, 2012

(54) CONTINGENT LABOR MANAGEMENT

(76) Inventors: Delvin Charles Hanson, Fullerton, CA (US); Matthew Carney Forbes, Marlborough, MA (US)

(21) Appl. No.: 13/402,364

(22) Filed: Feb. 22, 2012

Related U.S. Application Data
(60) Provisional application No. 61/447,924, filed on Mar. 1, 2011.

(51) Int. Cl. G06Q 90/00

(52) U.S. Cl. 705/500

(57) ABSTRACT

A process for managing contingent labor costs includes, following occurrence of a predetermined event indicative of a point at which a staffing firm has earned a threshold revenue from a contingent worker recruited by the staffing firm, causing the contingent worker to become an employee of a maintenance firm; providing a labor consumer with services generated by said employee; and receiving revenue from said labor consumer for said services

### RELATED APPLICATIONS

This application claims the benefit of the priority date of U.S. Provisional Application 61/447,924, filed on Mar/ 1, 2011, the contents of which are herein incorporated by reference.

### FIELD OF DISCLOSURE

This disclosure relates to labor management, and in particular, to contingent workforce management.

### BACKGROUND

Many businesses hire contingent workers to fill short term needs. The use of contingent workers is advantageous to businesses for a variety of reasons, including flexibility in staffing up or down as needs require, and access to specialized expertise that may not be readily available within the business.

These contingent workers are provided by staffing firms. Staffing firms recruit contingent workers from the labor pool and hire them out to businesses in exchange for an hourly rate that is often quite high. The contingent workers thus remain employees of the staffing firm.

The foregoing arrangement is advantageous because the staffing firm attends to the initial details associated with recruiting and placing a contingent worker. However, the arrangement can also be unduly expensive, particularly when a contingent worker works at the same place for an extended period.

### SUMMARY

In one aspect, the invention features a process for managing contingent labor costs. Such a process includes, following occurrence of a pre-determined event indicative of a point at which a staffing firm has earned a threshold revenue from a contingent worker recruited by the staffing firm, causing the contingent worker to become an employee of a maintenance firm; providing a labor consumer with services generated by said employee; and receiving revenue from said labor consumer for said services.

Alternative practices include those in which the event includes payment of a finder's fee to the staffing firm, lapse of an interval following a start of the contingent worker's employment lifetime, and lapse of an interval at the end of which the staffing firm has received a defined revenue from the employment of the contingent worker.

Yet other practices include those in which wherein the staffing firm hires out the contingent worker at a first hourly rate, and after occurrence of said event, said maintenance firm hires out said contingent worker at a second hourly rate, said second hourly rate being less than said first hourly rate.

Also among the practices are those in which receiving revenue includes receiving a tangible negotiable instrument that can be transformed, through exchange, into a tangible good, and those in which receiving revenue includes receiving a tangible electromagnetic wave at a particular machine, said tangible electromagnetic wave bearing information representative of an amount of value that can be exchanged for a tangible good.

### BRIEF DESCRIPTION OF THE DRAWINGS

FIG. 1 is a staffing system;

FIG. 2 is a plot of hourly rate for a staffing system as shown in FIG. 1;

FIG. 3 is a plot of an hourly rate with variable spread associated with a staffing system that includes a maintenance firm;

FIG. 4 shows the staffing system of FIG. 1 after the occurrence of a trigger event at one labor consumer;

FIG. 5 shows the staffing system of FIG. 4 after the occurrence of a trigger event at a second labor consumer; and

FIG. 6 shows the staffing system of FIG. 5 after the occurrence of a trigger event at a third labor consumer and the addition of a fourth labor consumer serviced by a staffing firm.

### DETAILED DESCRIPTION

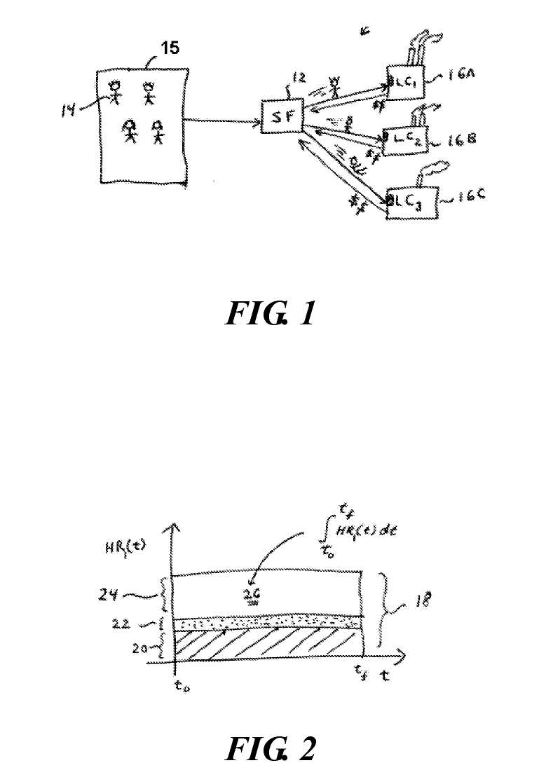

FIG. 1 shows a typical staffing system 10 in which a staffing firm 12 recruits contingent workers 14 from a labor pool 15 and provides them to labor consumers 16A-16C. In exchange, each labor consumer 16A-16C pays the staffing firm 12 an hourly rate 18, shown in FIG. 2.

A typical staffing firm 12 expends considerable resources to perform certain start-up tasks associated with each contingent worker 14. These start-up tasks include locating and recruiting the contingent worker 14, and identifying a labor consumer 16A-16C that requires the services of the contingent worker 14. Once the contingent worker 14 has been placed, the staffing firm 12 has little to do but certain administrative tasks associated with employment. These tasks tend to be routine in nature, easy to automate, and relatively low cost.

To earn back the costs associated with the start-up tasks, and to earn a healthy profit within a reasonable period of time, the staffing firm 12 charges a relatively high first hourly rate 18, as shown in FIG. 2. This first hourly rate 18 includes a pay rate 20, which is paid to the contingent worker 14, and a burden rate 22, which represents costs associated with the contingent worker 14. The residual portion of the first hourly rate 18 is a first spread rate 24. This first spread rate 24 represents profit to the staffing firm 12. The integral 26 of the first spread rate 24 over the employment lifetime 27 of the contingent worker 14 represents a cumulative amount earned by a staffing firm 12 for a particular contingent worker 14.

Where contingent workers 14 stay for limited periods, the first hourly rate 18 shown in FIG. 2 is not unduly burdensome for labor consumers 16A-16C. Despite the high first hourly rate 18, the labor consumer 16A-16C avoids recruitment tasks, and avoids a long term commitment to its workers 14. Although the first hourly rate 18 is higher than what an equivalent employee would cost, the contingent worker 14 is not expected to stay employed indefinitely. Consequently, the high hourly rate 18, when integrated over the employment lifetime 27 of a contingent worker 14, is not unreasonable.

However, as a practical matter, contingent workers 14 often become entrenched at a labor consumer 16A for extended employment lifetimes 27. When this happens, the labor consumer 16A continues to pay the relatively high first hourly rate 18 long after the staffing firm 12 has earned back its start-up costs and made a reasonable profit for its placement services. As a result, for much of a contingent worker's career at a labor consumer 16A, the labor consumer 16A may be paying a disproportionately high hourly rate 18 for little more than routine worker maintenance. Because of the extended integration interval resulting from the extended employment lifetime 27, the integral of the hourly rate, and hence the cumulative cost of to a labor consumer 16A, is high.

The foregoing is a desirable state of affairs for staffing firms 12 since for much of a contingent worker's career at a particular labor consumer 16A, the staffing firm 12 earns a high hourly rate 18 for doing essentially routine administrative tasks associated with maintaining employees. This results in an extremely high profit margin for a staffing firm 12.

However, from a labor consumer's point of view, for much of a contingent worker's employment lifetime 27, a staffing firm's primary value added, namely its ability to recruit and place workers, is ancient history. From a labor consumer's point of view, the staffing firm 12 has long since earned a respectable profit for its placement services, and is now earning a profit that is inappropriate for work that is of lesser value. Nevertheless, most labor consumers 16A-C, if satisfied with a contingent worker 14, are unwilling to disturb the equilibrium.

To avoid the above difficulty, it is useful for a maintenance firm 28 to inherit employee maintenance tasks upon the occurrence of a pre-determined trigger event. The pre-determined trigger event may be, for example, that a particular time interval has lapsed since the beginning of the contingent worker's employment lifetime 27, or that the staffing firm 12 has earned a predetermined profit. In some cases, the pre-determined profit is earned during a first portion of the employment lifetime 27. However in other cases, the pre-determined profit is earned upon placement of a contingent worker 14, for example upon payment of a finder's fee to the staffing firm 12.

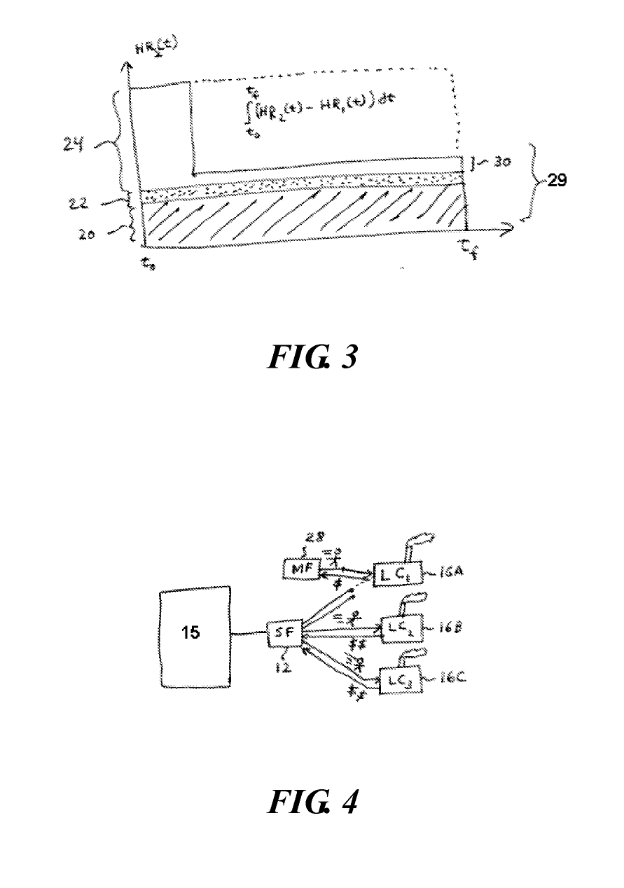

Upon the occurrence of the pre-determined trigger event, the maintenance firm 28 becomes the employer-of-record for the contingent worker 14. At that point, the first hourly rate 18 is set to a second hourly rate 29, as shown in FIG. 3. This second hourly rate 29 is lower than the first hourly rate 18 that would have been charged by the staffing firm 12. Meanwhile, the pay rate 20 remains what it would have been had the staffing firm 12 been the employer-of-record. This results in a reduced spread rate 30 for the maintenance firm 28. However, the maintenance firm 28 does not incur the large expenses the staffing firm 12 incurred in identifying and placing the contingent worker 14 in the first place. Thus, the reduced spread rate 30 is entirely adequate to cover the maintenance costs of the contingent worker 14 and ensure a healthy profit for the maintenance firm 28, even though it would be inadequate for a staffing firm 12.

In some cases, the maintenance firm 28 becomes a second employer-of-record, with the first employer-of-record having been the staffing firm 12. However, in other cases, the first and only employer-of-record is the maintenance firm 28. This may occur, for example, where the staffing firm 12 simply identifies a candidate contingent worker 14, who is then hired by the maintenance firm 28 and immediately placed with the labor consumer 16A. In that case, another entity, for example the labor consumer 16A or the maintenance firm 28, pays a finder's fee to the staffing firm 12, at which point the maintenance firm 28 becomes the employer-of-record.

FIG. 4 shows the staffing system of FIG. 1 after a predetermined trigger event has occurred in connection with the first labor consumer 16A. As a result of the trigger event, the maintenance firm 28 is now the employer-of-record. As a result, the first labor consumer 16A now pays a lower second hourly rate 29, which in turn reduces the first spread rate 24 to a second spread rate 30. Meanwhile, since no predetermined trigger event has occurred in connection with the second and third labor consumers 16B, 16C, the staffing firm 12 remains employer-of-record. Those labor consumers 16B, 16C thus continue to pay a higher first hourly rate 18.

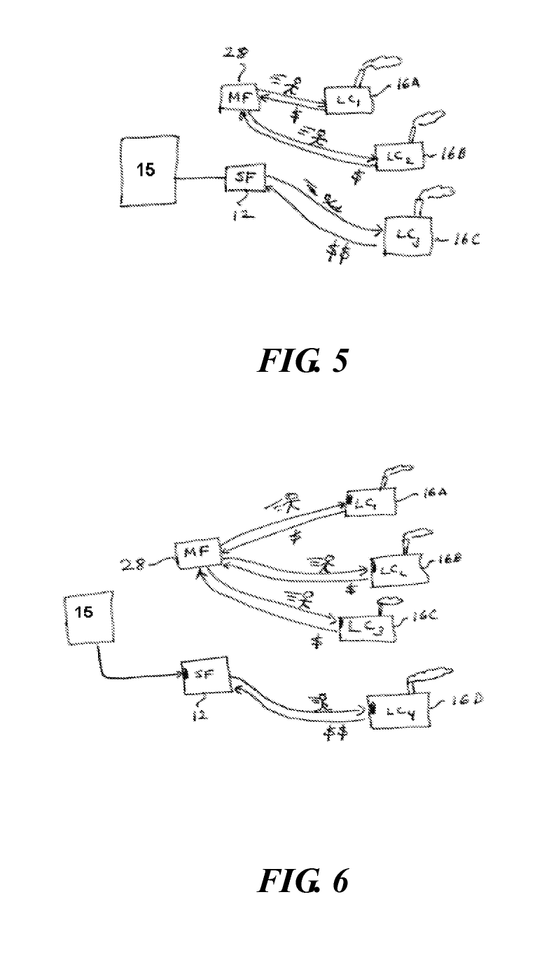

In FIG. 5, a predetermined trigger event has occurred in connection with the second labor consumer 16B. As a result, the maintenance firm 28 has now become the employer-of-record for contingent workers 14 at the second labor consumer 16B as well as those at the first labor consumer 16A. This increases revenue for the maintenance firm 28. Meanwhile, as no predetermined trigger event has occurred in connection with the third labor consumer 16C, that labor consumer 16C continues to pay a higher hourly rate.

In FIG. 6, a predetermined trigger event has finally occurred in connection with the third labor consumer 16C. As a result, the maintenance firm 28 has become the employer-of-record for contingent workers 14 at the third labor consumer 16C, thus further increasing its revenue stream. Meanwhile, a fourth labor consumer 16D in need of contingent workers 14 is now doing business with the staffing firm 12.

Once the staffing firm 12 has placed contingent workers 14 at the fourth labor consumer 16D, a pre-determined trigger event is defined. Eventually, when that trigger event occurs, the maintenance firm 28 will become employer-of-record for yet another set of contingent workers 14, this one originating from the fourth labor consumer 16D. This increases revenue for the staffing firm 12.

It is apparent therefore that the staffing firm 12 effectively functions as a feeder for the maintenance firm 28. Each time the staffing firm 12 places contingent workers 14, a predetermined trigger event is defined, the occurrence of which will cause the contingent workers 14 to migrate from being associated with the staffing firm 12, either as employees are as recruited candidates for employment, to being employees of the maintenance firm 28. As a result, through a slow but relentless process of accretion, revenue growth at the maintenance firm 28 continues unabated, limited only by an extent to which a rate of attrition approaches or exceeds a rate of accretion. Meanwhile, the staffing firm 12 continues to do what it does best: to identify and recruit talent in the labor pool 15, either on behalf of new labor consumers 16D or on behalf of labor consumers 16A-16D for which it has previously worked. Finally, the labor consumer 16A eventually enjoys a lower hourly rate 29, comparable to what it might pay its regular employees, for entrenched contingent workers 14.

In order for the foregoing method to be self sustaining in function, the various entities involved, i.e. the staffing firm 12, the maintenance firm 28, and the contingent workers 14, will require incentives to participate. Many incentives are possible, including the acquisition of intangible goodwill, the desire to perform acts characterized by an intangible quality, such as a desire to do good or to help others with no thought of reward.

For a minority of people, intangible incentives are powerful ones. But for most people, this is not the case.

Accordingly, there exist two practices of the method described herein. In one, parties are motivated through exchange of intangibles such as good will and the desire to do good, to contribute to their community, or even for sheer enjoyment. These particular practices do not involve transformation of matter since goodwill, good, enjoyment, and contribution to the community are not made of matter. Thus, the foregoing practices, and all practices that are motivated purely by intangibles, are not the subject matter of the claims.

Although intangible incentives are powerful ones, it has been discovered that a particularly reliable method for motivating the various parties arises from the exchange of material goods, i.e. for the transformation of matter. Such transformations arise in part from transporting matter or transmitting electromagnetic waves through matter, and are believed to be inherent in transferring possession of matter from one party to another or to the endowment of a possessory interest in a material good or negotiable instrument to a party.

Motivation through exchange of matter also has the advantage of being far more readily quantifiable that motivation through exchange of intangibles. It has been found, for example, that contingent workers 14 who are asked to work in exchange for mere goodwill, or simply to be gratuitously helpful tend not to be as reliable in their working habits as their counterparts who are asked to work in exchange for matter in various forms, a number of which are described below. Thus, matter is known to operate as a kind of fuel that, when circulated through the entities described herein, causes the entities involved in execution of the method to cooperate more reliably.

In some practices of the invention, the various entities involved in the foregoing method can exchange tangible goods. For example, one entity may transfer livestock, agricultural products, precious metals, such as gold, and silver, or gem stones to another party. The transportation of such material goods, of course, represents a transformation of matter since matter is being transported from one place to another.

However, because of logistical difficulties, to designate certain other kinds of matter to function as media of exchange. Thus, it is convenient and conventional to exchange other forms of matter, such as coins, paper bills, or checks and other negotiable instruments. These too all have attributes of matter, and are indeed matter, and hence the method described above, in these embodiments, also involves a transformation of matter.

In some other practices, to avoid the disadvantages of using negotiable instruments or currency, other forms of matter can be exchanged or manipulated so as to represent transfer of other forms of matter.

Examples of matter that is so manipulated include charged particles, such as electrons, which are manipulated in an effort to represent transfer of other matter from one entity to another. There is no disputing that electrons have mass, which is a key attribute of matter, and that electrons are transformed in such cases by electrical circuits, such as those in digital computers, associated with and tied to particular machines. Typical manipulation includes the propagation of an electromagnetic wave through a conductor or optical fiber that leads at least part of the way from one computer to another. This results in the movement of electrons through the doped semiconductor material that makes up parts of transistors that are found in modern computers. In many cases, particularly where the transistors are field effect transistors, the transformation goes so far as to open up a conducting channel between doped source and drain regions of the transistor, thus allowing a measurable current to flow between source and drain of many transistors at once. Thus, these embodiments likewise involve the transformation of matter.

As used herein, the term “revenue” is intended to encompass all forms of matter transformed through transfer between parties in the above-mentioned method, and matter that is manipulated in connection with the transfer of value from one party to another including but not limited to those described above. The term “revenue” explicitly excludes intangible abstractions.

It should be noted that the assemblage of transistors operating as switches in a typical computer, and the communication paths that facilitate propagation of electromagnetic waves between such computers form an intricate and complex machine particular to the method described herein. The method can thus be viewed as tied to, or otherwise associated with this particular machine. It should be apparent as well that the block diagram shown in FIG. 1 and FIGS. 4-6 can be interpreted readily as a block diagrams for different embodiments of such a particular machine.

It is important to note that the foregoing examples of matter transformation are not incidental to or ancillary to the methods claimed herein. In fact, the foregoing examples of matter transformation are the very reason that the method would be exercised at all.

It should also be noted that the particular machine described above is not essential to every embodiment of the invention, but is disclosed as a particularly efficient mechanism for manipulation of matter that ultimately represents transfer of other forms of matter, or rights to such transfer, among parties involved in the method.

Thus, there are many practices of the method that do not involve transformation or exchange of matter. The claims are directed only to a limited subset of the foregoing methods that does indeed involve the transformation of matter. It is only these methods that are the subject matter of the claims.

The abstract idea underlying the invention is the idea that one can earn more revenue by increasing volume rather than by increasing margin. However, this abstract idea is not what is claimed, and indeed cannot be claimed. Instead, the claims are directed to a specific and practical method of achieving revenue growth in a particular specialized field, namely staffing with contingent laborers. Thus, the claims do not pre-empt all applications of or ways of implementing the abstract idea that underlies the claims. Therefore, the claims appended hereto are not abstract and involve transformation of matter.

Having described the invention, and a preferred embodiment thereof, what we claim as new, and secured by letters patent, is:

1. A process for managing contingent labor costs, said process comprising:
following occurrence of a pre-determined event indicative of a point at which a staffing firm has earned a threshold revenue from a contingent worker recruited by the staffing firm, causing the contingent worker to become an employee of a maintenance firm; providing a labor consumer with services generated by said employee; and receiving revenue from said labor consumer for said services.

2. The process of claim 1, wherein the event comprises payment of a finder's fee to the staffing firm.

3. The process of claim 1, wherein the event comprises lapse of an interval following a start of the contingent worker's employment lifetime.

4. The process of claim 1, wherein the event comprises lapse of an interval at the end of which the staffing firm has received a defined revenue from the employment of the contingent worker.

5. The process of claim 1, wherein the staffing firm hires out the contingent worker at a first hourly rate, and after occurrence of said event, said maintenance firm hires out said contingent worker at a second hourly rate, said second hourly rate being less than said first hourly rate.

6. The process of claim 1, wherein receiving revenue comprises receiving a tangible negotiable instrument that can be transformed, through exchange, into a tangible good.

7. The process of claim 1, wherein receiving revenue comprises receiving a tangible electromagnetic wave at a particular machine, said tangible electromagnetic wave bearing information representative of an amount of value that can be exchanged for a tangible good.
